(19) United States
(12) Patent Application Publication
(10) Pub. No.: US 2022/0001405 A1
(43) Pub. Date: Jan. 6, 2022

(54) PLASMA TORCH, PLASMA GENERATOR, AND ANALYSIS DEVICE

(71) Applicant: National Institute of Advanced Industrial Science and Technology, Tokyo (JP)

(72) Inventors: Kazumi Inagaki, Tsukuba-shi (JP); Yoshiyuki Teramoto, Tsukuba-shi (JP); Shinichiro Fujii, Tsukuba-shi (JP); Shinichi Miyashita, Tsukuba-shi (JP)

(73) Assignee: National Institute of Advanced Industrial Science and Technology, Tokyo (JP)

(21) Appl. No.: 17/291,675

(22) PCT Filed: Nov. 8, 2019
(86) PCT No.: PCT/JP2019/043965

§ 371 Date: May 6, 2021

(30) Foreign Application Priority Data
Nov. 16, 2018 (JP) 2018-215366

(51) Int. Cl. B05B 7/06; G01N 27/68; H05H 1/30

(52) U.S. Cl. CPC B05B 7/066; H05H 1/30; G01N 27/68

(57) ABSTRACT

The present invention provides a plasma torch which comprises: a first pipe having a first flow channel through which a liquid can flow, a first exit through which the liquid is sprayed being provided on an one end side; a second pipe body that surrounds the first pipe body, and has a second flow channel through which a gas can flow, a second exit through which the gas is sprayed being provided on the one end side; and an electrode extending into the second flow channel. The second exit is provided further to the one end side than the first exit, some of the inner peripheral surface of the second pipe decreases in diameter towards the second exit, and the diameter of the inner peripheral surface closer to the second exit than the first exit is equal to or larger than the opening diameter of the first exit.

### TECHNICAL FIELD

The present invention relates to a technique for generating a microplasma jet by ejecting, through pores, a plasma generated through dielectric breakdown of a gas due to an electrical discharge, using the flow of the gas. More particularly, the present invention relates to a plasma torch for ejecting a microplasma jet, a plasma generator having the plasma torch, and an analysis device.

### BACKGROUND ART

For microplasma jets, a non-thermal equilibrium plasma being a plasma having a gas temperature of 100° C. or lower is formed. Microplasma jets have therefore been applied in a variety of fields. Examples of major application fields thereof include the fields of chemical analysis and manufacturing processes. Examples of non-thermal equilibrium microplasma jets that are commonly used in these fields include those that use dielectric barrier discharge (DBD) and those that use what may be referred to as “after glow discharge” in glow discharge.

If a liquid is introduced directly into a non-thermal equilibrium microplasma jet, the plasma cannot be sustained and turns off. This is thought to be largely due to influences of factors such as energy absorption load and volume expansion load in evaporation and vaporization of the liquid.

There has been a method that involves introducing a liquid aerosol or a vapor into an atmospheric pressure plasma discharge, and a method involving vaporizing a liquid and introducing a resulting gas flow through a liquid supply nozzle of an outlet that is located upstream or midway of a microplasma gas supply tube and oriented substantially perpendicular to the supply tube (see, for example, Patent Documents 1 and 2). These methods need not only a microplasma jet unit but also a unit for generating the liquid aerosol or vapor and an outlet for jetting the liquid.

In order to simplify such a complicated configuration, a known torch includes a tubular duct and, in the tubular duct, a coaxial double pipe nebulizer including a separation duct through which a process gas flows and a transport duct through which a liquid flows. This torch generates a plasma in an ionized gas flowing through the tubular duct using two pairs of coaxial electrodes provided on the outside of the tubular duct and directly sprays the liquid into the plasma using the process gas (see Patent Document 3).

Meanwhile, a known sprayer using DBD, which is used in a chemical analysis instrument, includes an electrode provided around a spraying nozzle and a counterpart electrode located downstream thereof in a spraying direction, and a known method involves spraying a liquid into DBD occurring between the electrodes (see Non-Patent Document 1).
Patent Document 1: Japanese Unexamined Patent Application (Translation of PCT Application), Publication No. 2010-538829
Patent Document 2: Japanese Unexamined Patent Application, Publication No. 2006-274290
Patent Document 3: Japanese Unexamined Patent Application (Translation of PCT Application), Publication No. 2017-504928
Non-Patent Document 1: X. Liu et al., “Determination of trace cadmium in rice by liquid spray dielectric barrier discharge induced plasma-chemical vapor generation coupled with atomic fluorescence spectrometry”, Spectrochim. Acta B, 141 (2018) 15-21

### DISCLOSURE OF THE INVENTION

### Problems to be Solved by the Invention

The torch described in Patent Document 3 disadvantageously needs two gas flows: that of an ionized gas in which a plasma is formed and that of a process gas for spraying. Furthermore, the coaxial double pipe nebulizer illustrated in FIG. 4 needs a gap between the separation duct, through which the process gas flows, and the transport duct to be very small, and the pressure for supplying the process gas to be very high, in order to spray fine droplets.

According to the method disclosed in Non-Patent Document 1, the need for the electrode located downstream in the spraying direction disadvantageously makes it impossible to bring a plasma jet in direct contact with a target to which the plasma jet is ejected. The need for this electrode also makes it impossible to perform observation or sampling of any product in the plasma jet in a plasma jet generation direction.

In order to solve the above-described problems, it is an object of the present invention to provide a plasma torch, a plasma generator, and an analysis device that are novel and useful, and that are capable of introducing a liquid into a plasma and stably ejecting a plasma jet.

### Means for Solving the Problems

According to an aspect, the present invention provides a plasma torch capable of ejecting a plasma jet from one end thereof, the plasma torch including: a first tube having a first channel that allows a liquid to flow therethrough, the first tube having a first outlet from which the liquid is ejected toward the one end; a second tube surrounding the first tube with a gap therebetween and having a second channel that allows a gas to flow therethrough, the second tube having a second outlet from which the gas is ejected toward the one end, the second channel being defined by an outer circumferential surface of the first tube and an inner circumferential surface of the second tube; and an electrode extending in the second channel and having a tip located further toward an end opposite to the one end than the first outlet, the electrode being configured to receive a high-frequency voltage applied from the opposite end to form an atmospheric-pressure non-thermal equilibrium plasma in the gas, the second outlet being located further toward the one end than the first outlet, at least a portion of the inner circumferential surface of the second tube having a diameter that progressively decreases toward the second outlet, another portion of the inner circumferential surface of the second tube having a diameter that is equal to or greater than an opening diameter of the first outlet, the other portion of the inner circumferential surface of the second tube being located further toward the second outlet than the first outlet.

According to this aspect, the liquid ejected from the first outlet of the first tube can be atomized into fine droplets by the gas in which the atmospheric-pressure non-thermal equilibrium plasma has been formed, and the droplets of the liquid can be introduced into the plasma while focusing (converging) onto the central axis or the vicinity thereof of the plasma. This feature makes it possible to directly introduce the liquid into the atmospheric-pressure non-thermal equilibrium plasma without letting the atmospheric-pressure non-thermal equilibrium plasma turn off. As a result, the plasma torch provided by the present invention can introduce the liquid and stably eject, in the form of a plasma jet, a component of the liquid that has reacted with the atmospheric-pressure non-thermal equilibrium plasma.

According to another aspect, the present invention provides a plasma generator including: a liquid supply source configured to supply a liquid; a gas supply source configured to supply a gas; a high-frequency power source; and the plasma torch according to the foregoing aspect. In the plasma torch, the second tube is connected to the gas supply source, the first tube is connected to the liquid supply source, and the electrode is connected to the high-frequency power source. The plasma torch forms an atmospheric-pressure non-thermal equilibrium plasma in the gas using a high-frequency voltage applied from the high-frequency power source to the electrode and forms a plasma jet by ejecting a flow of the gas carrying the atmospheric-pressure non-thermal equilibrium plasma from the second channel and ejecting droplets of the liquid from the first outlet to the flow of the gas. According to this aspect, the plasma generator provided by the present invention includes the plasma torch according to the foregoing aspect.

According to another aspect, the present invention provides an analysis device including: the plasma generator according to the foregoing aspect; and an analysis unit configured to analyze an atomized or ionized component of the liquid included in the plasma jet.

According to this aspect, the plasma generator according to the foregoing aspect atomizes the liquid being ejected into fine droplets using the flow of the gas in which the atmospheric-pressure non-thermal equilibrium plasma has been formed. The plasma generator also keeps the droplets from dispersing using the flow of the gas, so that the droplets are introduced into the atmospheric-pressure non-thermal equilibrium plasma while focusing onto the central axis or the vicinity thereof of the atmospheric-pressure non-thermal equilibrium plasma. As a result, the liquid can be directly introduced into the atmospheric-pressure non-thermal equilibrium plasma. The analysis device can therefore efficiently perform the analysis while reducing loss during the reduction of the liquid into droplets.

### BRIEF DESCRIPTION OF THE DRAWINGS

FIG. 1 is a diagram schematically illustrating a configuration of a plasma generator according to a first embodiment of the present invention;

FIG. 2 is a view of the plasma generator according to the first embodiment of the present invention along arrows Y-Y in FIG. 1;

FIG. 3 is a diagram schematically illustrating a configuration of a plasma generator according to a second embodiment of the present invention;

FIG. 4 is a view of the plasma generator according to the second embodiment of the present invention along arrows Y-Y in FIG. 3;

FIG. 5 is a diagram schematically illustrating a configuration of a plasma generator according to a third embodiment of the present invention;

FIG. 6 is a diagram schematically illustrating a configuration of an analysis device according to an embodiment of the present invention;

FIG. 7 is a diagram showing a plasma jet ejected by a plasma generator of Example 1;

FIG. 8 is a diagram showing particle size distribution by volume of gold nanoparticles generated using a plasma generator of Example 2;

FIG. 9 is a diagram showing signal intensity of arsenic with respect to four arsenic compounds measured using analysis devices of Example 3 and Comparative Example 1; and

FIG. 10 is a diagram showing signal intensity of mercury in reduction and vaporization of mercury ions measured using the analysis devices of Example 4 and Comparative Example 2.

### PREFERRED MODE FOR CARRYING OUT THE INVENTION

The following describes embodiments of the present invention with reference to the drawings. Note that elements that are common between a plurality of drawings are denoted by the same reference characters, and detailed description of such elements will not be repeated.

### First Embodiment

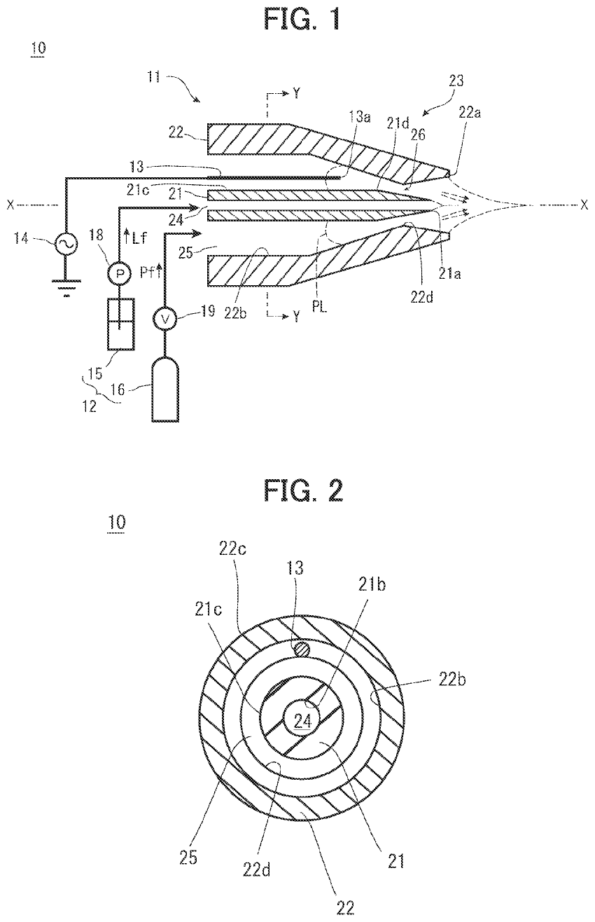

FIG. 1 is a diagram schematically illustrating a configuration of a plasma generator according to a first embodiment of the present invention. FIG. 2 is a view along arrows Y-Y in FIG. 1. Referring to FIGS. 1 and 2, a plasma generator 10 according to the first embodiment includes a plasma torch 11 that ejects a plasma jet, a supply unit 12 that supplies a sample liquid Lf and a plasma gas Pf to the plasma torch 11, and a high-frequency power source 14 that generates a high-frequency voltage and supplies the high-frequency voltage to an electrode 13 of the plasma torch 11. The plasma torch 11 has a nozzle 23 at one end thereof (also referred to below as an ejection end) and receives supply of the sample liquid Lf and the plasma gas Pf at an opposite end (also referred to below as a supply end).

The supply unit 12 has a sample liquid supply source 15 and a plasma gas supply source 16. The sample liquid supply source 15 contains the sample liquid, which is sent to a channel 24 of a liquid supply tube 21 by a pump 18, for example.

The plasma gas supply source 16 contains the plasma gas Pf, which is supplied to a channel 25 via a valve 19. Examples of gases usable as the plasma gas Pf include inert gases such as helium (He), neon (Ne), and argon (Ar). Nitrogen (N₂) and oxygen (O₂), for example, are also usable as the plasma gas Pf.

The high-frequency power source 14 has an output connected to an end of the electrode 13 at the supply end. The high-frequency power source 14 is grounded. The high-frequency power source 14 applies a high-frequency voltage to the electrode 13, thereby ionizing the plasma gas Pf to form an atmospheric-pressure non-thermal equilibrium plasma. The atmospheric-pressure non-thermal equilibrium plasma may be a plasma generated through a dielectric barrier discharge or may be a plasma generated through an atmospheric pressure glow discharge. In the case of formation of a dielectric barrier discharge, a high-frequency voltage of a sinusoidal waveform, a triangular waveform, a sawtooth waveform, or a pulsed waveform having a frequency of 1 Hz to 100 kHz is preferable. In the case of formation of an atmospheric pressure glow discharge, a high-frequency voltage of a sinusoidal waveform or a pulsed waveform having a frequency of 100 Hz to 1000 kHz is preferable. The high-frequency voltage to be outputted by the high-frequency power source 14 is preferably set to a value that gives an electric power of from 0.1 W to 500 W. Hereinafter, an atmospheric-pressure non-thermal equilibrium plasma is also referred to simply as a plasma.

The plasma torch 11 has the liquid supply tube 21, a gas supply tube 22 surrounding the liquid supply tube 21, and the electrode 13 for generating a plasma. The plasma torch 11 has the nozzle 23 for ejecting a plasma jet. Preferably, the liquid supply tube 21 and the gas supply tube 22 form a double tube structure and are coaxial (central axis X-X) with each other.

The liquid supply tube 21 has the channel 24 defined by an inner circumferential surface 21b of the liquid supply tube 21 and extending in the axial direction. The sample liquid Lf supplied from the sample liquid supply source 15 through the supply end of the plasma torch 11 flows through the channel 24 and is directly ejected into a plasma PL from a first outlet 21a located toward the end having the nozzle 23. In terms of inhibiting clogging, the liquid supply tube 21 preferably has an inner diameter of 5 μm or more and 500 μm or less.

The gas supply tube 22 surrounds the liquid supply tube 21 with a gap therebetween, and the gap defined by an outer circumferential surface 21c of the liquid supply tube 21 and an inner circumferential surface 22b of the gas supply tube 22 forms the channel 25 extending in the axial direction. The plasma gas Pf supplied from the plasma gas supply source 16 flows through the channel 25. As described below, the electrode 13 forms an atmospheric-pressure non-thermal equilibrium plasma using the plasma gas Pf as a medium. The thus formed plasma PL is ejected using the flow of the plasma gas Pf. Through the above, droplets of the sample liquid Lf are ejected from the first outlet 21a of the liquid supply tube 21 into the flow of the plasma PL ejected. At the same time, the droplets of the sample liquid Lf are kept from dispersing to focus onto the central axis by the flow of the plasma PL and react with the plasma PL.

In terms of ensuring a space for accommodating the electrode 13, the gap (forming the channel 25) between the inner circumferential surface 22b of the gas supply tube 22 and the outer circumferential surface 21c of the liquid supply tube 21 is preferably 100 μm or more at the supply end.

The electrode 13 is disposed within the channel 25 and extends from the supply end toward the nozzle 23. A tip 13a of the electrode 13 is located further toward the supply end than the first outlet 21a of the liquid supply tube 21. The electrode 13 receives a high-frequency voltage applied by the high-frequency power source 14, thereby ionizing the plasma gas Pf at the tip 13a of the electrode 13 and thus forming an atmospheric-pressure non-thermal equilibrium plasma. The flow of the plasma gas Pf forms a plasma jet at a second outlet 22a. The plasma torch 11 has a configuration that does not have a counterpart electrode paired with the electrode 13. That is, no other electrodes are provided downstream of the second outlet 22a in an ejection direction of the plasma jet. This configuration reduces restrictions on an ejection target, and also reduces restrictions on observation and sampling of the plasma jet.

An electrically conductive material such as titanium (Ti), platinum (Pt), or tungsten (W) is usable for the electrode 13. In terms of facilitating smooth flow of the plasma gas Pf within the channel 25, the electrode 13 is preferably wire-shaped or rod-shaped. For example, a Pt wire having a diameter of several hundreds μm can be used for the electrode 13.

At least portions of the liquid supply tube 21 and the gas supply tube 22 that form the nozzle 23 are made from a dielectric material or an insulating material, and are preferably made from quartz glass, in particular, fused silica glass or a polyether ether ketone (PEEK) resin. Upon application of a high-frequency voltage from the electrode 13, a dielectric barrier discharge occurs in the plasma gas Pf, allowing formation of a plasma.

In the nozzle 23, the second outlet 22a of the gas supply tube 22 is located further toward the ejection end than (downstream of) the first outlet 21a of the liquid supply tube 21. The liquid supply tube 21 and the gas supply tube 22 are preferably arranged such that the distance between the first outlet 21a and the second outlet 22a is 10 μm or more and 1000 μm or less. The gas supply tube 22 has a shape in which at least a portion of the inner circumferential surface 22b has a diameter that progressively decreases toward the second outlet 22a, and another portion of the inner circumferential surface 22b located further toward the second outlet 22a than the first outlet 21a has a diameter that is equal to or greater than an opening diameter of the first outlet 21a. According to such a structure, the plasma torch 11 can atomize, into fine droplets, the sample liquid Lf being ejected from the first outlet 21a of the liquid supply tube 21, using the plasma gas Pf in which the atmospheric-pressure non-thermal equilibrium plasma (plasma PL) has been formed, and the droplets of the sample liquid Lf can be introduced into the plasma PL while focusing onto the central axis X-X or the vicinity thereof of the plasma PL due to a flow-focus effect. This feature makes it possible to directly introduce the sample liquid Lf into the plasma PL without letting the plasma PL turn off. As a result, the plasma torch 11 can stably eject, in the form of a plasma jet, a component of the sample liquid Lf that has reacted with the plasma PL. In the plasma torch 11, the electrode 13 is disposed within the channel 25, and the tip 13a thereof is located further toward the supply end than the first outlet 21a of the liquid supply tube 21. That is, the electrode 13 does not extend to the plasma jet ejection end, making it possible to reduce restrictions on the shape or the size of the target to which the plasma jet is ejected. In terms of promoting the flow-focus effect of the plasma gas Pf, the inner circumferential surface 22b of the gas supply tube 22 preferably has a diameter that progressively decreases at least to the first outlet 21a in a direction from the supply end toward the second outlet 22a.

The inner circumferential surface 22b of the gas supply tube 22 may have a diameter that is constant or progressively increases from a location 22d toward the second outlet 22a. Such a configuration makes it possible to inhibit turbulence in the plasma gas Pf carrying the plasma ejected from the location 22d, because no member blocks the flow of the plasma gas Pf.

The channel 25 preferably has a constriction portion 26 that allows the plasma gas pf to flow therethrough and that is located further toward the supply end than the first outlet 21a. The channel 25 preferably has a channel area that progressively decreases from the supply end to the constriction portion 26. In such a configuration, the flow rate (linear velocity) of the plasma gas Pf increases as a result of the plasma gas Pf passing through the constriction portion 26, promoting the atomization, into fine droplets, of the sample liquid Lf being ejected from the first outlet 21a into the plasma PL and promoting the flow-focus effect. Thus, the droplets of the sample liquid Lf can be ejected into the plasma PL at a narrower angle (i.e., in a smaller lateral spreading range with respect to the ejection direction), as compared with a configuration including no constriction portion.

The constriction portion 26 in the first embodiment is provided at the location 22d. The constriction portion 26 has a shape in which the inner circumferential surface 22b of the gas supply tube 22 has a diameter that progressively decreases in a direction from the supply end toward the ejection end. The outer circumferential surface 21c of the liquid supply tube 21 has a diameter that decreases in the direction from the supply end toward the ejection end, which in other words is toward the first outlet 21a. The extent of the decrease in diameter of the inner circumferential surface 22b of the gas supply tube 22 relative to a length along the central axis X-X is greater, and thus the constriction portion 26 is formed. The constriction portion 26 is preferably located further toward the supply end than (upstream of) the first outlet 21a by 10 μm to 2000 μm. In terms of promoting the atomization of the sample liquid Lf into fine droplets, the distance between the inner circumferential surface 22b of the gas supply tube 22 and the outer circumferential surface 21c of the liquid supply tube 21 is preferably set to 5 μm to 30 μm in the constriction portion 26.

Note that the diameter of the outer circumferential surface 21c of the liquid supply tube 21 may be constant in the direction toward the first outlet 21a. Even such a configuration forms the constriction portion 26 at the location 22d. Note that the channel area refers to an area occupied by the channel 25 on a plane perpendicular to the central axis X-X.

The tip 13a of the electrode 13 is preferably located further toward the supply end than the constriction portion 26. In such a configuration, the plasma PL is generated at the tip 13a of the electrode 13, and then the plasma gas Pf being a medium of the plasma PL gains in flow rate as a result of passing through the constriction portion 26. Thus, the atomization, into fine droplets, of the sample liquid Lf being ejected from the first outlet 21a into the plasma PL can be promoted, and the droplets of the sample liquid Lf can be introduced into the plasma PL while focusing onto the central axis X-X or the vicinity thereof of the plasma PL. This feature makes it possible to introduce the sample liquid Lf into the plasma PL without letting the plasma PL turn off.

In the shape of the gas supply tube 22, the diameter of the inner circumferential surface 22b may progressively increase from the constriction portion 26 toward the second outlet 22a. Such a configuration makes it possible to inhibit turbulence in the plasma gas Pf carrying the plasma ejected from the constriction portion 26, because no member blocks the flow of the plasma gas Pf. The second outlet 22a of the gas supply tube 22 preferably has an opening diameter of 100 μm or more and 500 μm or less.

In terms of ejecting droplets of the sample liquid Lf in a smaller lateral spreading range with respect to the ejection direction using the flow-focus effect of the flow of the plasma gas Pf, the opening diameter of the first outlet 21a of the liquid supply tube 21 is preferably smaller than the diameter of the outer circumferential surface 21c of the liquid supply tube 21 in the constriction portion 26.

In terms of promoting the atomization of the sample liquid Lf into fine droplets, the inner circumferential surface 21b of the liquid supply tube 21 preferably has a diameter that progressively decreases toward the first outlet 21a. In terms of causing the plasma gas Pf to flow in a manner that allows the sample liquid Lf to be ejected while focusing, the outer circumferential surface 21c of the liquid supply tube 21 preferably has a diameter that progressively decreases toward the first outlet 21a. In terms of inhibiting, at the first outlet 21a, turbulence such as a vortex in the plasma gas Pf carrying the plasma, the liquid supply tube 21 is preferably pointed toward the first outlet 21a in a cross-sectional shape thereof taken in a longitudinal direction of the plasma torch 11.

### Second Embodiment

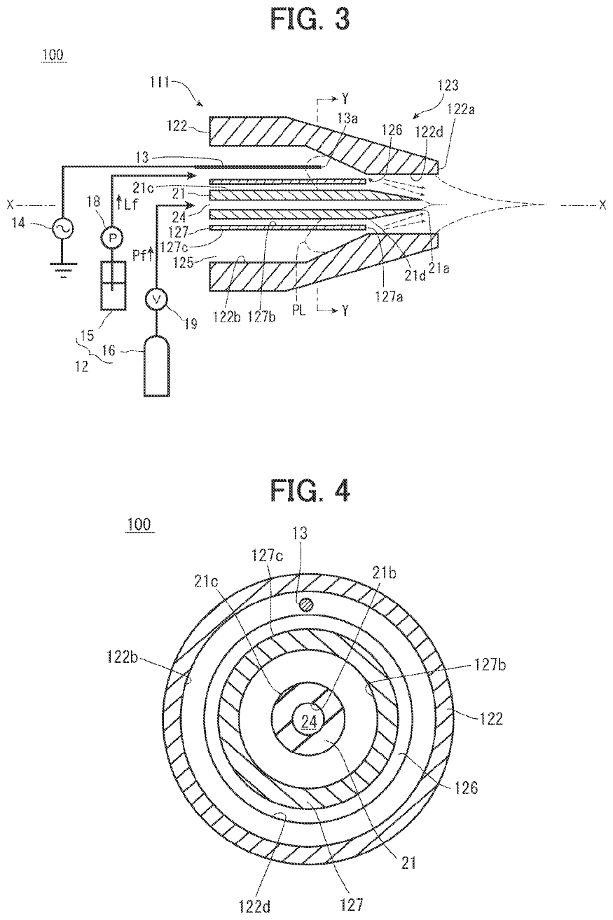

FIG. 3 is a diagram schematically illustrating a configuration of a plasma generator according to a second embodiment of the present invention. FIG. 4 is a view along arrows Y-Y in FIG. 3. Referring to FIGS. 3 and 4, a plasma generator 100 according to the second embodiment includes a plasma torch 111 that ejects a plasma jet, a supply unit 12 that supplies a sample liquid Lf and a plasma gas Pf to the plasma torch 111, and a high-frequency power source 14 that generates a high-frequency voltage and supplies the high-frequency voltage to an electrode 13 of the plasma torch 111.

The plasma torch 111 has a liquid supply tube 21, a protective tube 127 surrounding the liquid supply tube 21, a gas supply tube 122 surrounding the protective tube 127, and the electrode 13 for generating a plasma. The plasma torch 111 has a nozzle 123 for ejecting a plasma jet at one end thereof. The plasma torch 111 preferably has a triple tube structure in which the tubes are coaxial (central axis X-X) with one another.

The liquid supply tube 21 has the same configuration as the liquid supply tube 21 of the first embodiment described above. The gas supply tube 122 has substantially the same configuration as the gas supply tube 22 of the first embodiment described above. The gas supply tube 122 surrounds the protective tube 127 with a gap therebetween, and the gap defined by an outer circumferential surface 127c of the protective tube 127 and an inner circumferential surface 122b of the gas supply tube 122 forms a channel 125 extending in the axial direction. The plasma gas Pf supplied from a plasma gas supply source 16 flows through the channel 125. The electrode 13 forms an atmospheric-pressure non-thermal equilibrium plasma in the channel 125 using the plasma gas Pf as a medium.

In the nozzle 123, a second outlet 122a of the gas supply tube 122 is located further toward the ejection end than (downstream of) a first outlet 21a of the liquid supply tube 21. The gas supply tube 122 has a shape in which at least a portion of the inner circumferential surface 122b has a diameter that progressively decreases toward the second outlet 122a, and an inner circumferential surface 122d located further toward the second outlet 122a than the first outlet 21a has a diameter that is equal to or greater than an opening diameter of the first outlet 21a. According to such a structure, the sample liquid Lf being ejected from the first outlet 21a of the liquid supply tube 21 can be atomized into fine droplets using the plasma gas Pf, and the droplets of the sample liquid Lf can be introduced into the plasma PL while focusing onto the central axis X-X or the vicinity thereof of the plasma PL. This feature makes it possible to introduce the sample liquid Lf into the plasma PL without letting the plasma PL turn off. As a result, the plasma torch 111 can stably eject, in the form of a plasma jet, a component of the sample liquid that has reacted with the plasma.

The protective tube 127 has a tip 127a adjacent to the ejection end, and the tip 127a is located further toward the supply end than the first outlet 21a of the liquid supply tube 21. Preferably, the outer circumferential surface 127c of the tip 127a of the protective tube 127 and the inner circumferential surface 122b of the gas supply tube 122 form a constriction portion 126 of the channel 125. The constriction portion 126 is formed such that the channel 125 has a channel area that progressively decreases from the supply end to the constriction portion 126. The constriction portion 126 has a shape in which the inner circumferential surface 122b of the gas supply tube 122 has a diameter that progressively decreases in a direction from the supply end toward the ejection end. A tip 13a of the electrode 13 is preferably located further toward the supply end than the constriction portion 126. In such a configuration, the plasma PL is generated at the tip 13a of the electrode 13, and then the plasma gas Pf being a medium of the plasma PL gains in flow rate as a result of passing through the constriction portion 126. Thus, the atomization, into fine droplets, of the sample liquid Lf being ejected from the first outlet 21a into the plasma PL can be promoted, and the droplets of the sample liquid Lf can be introduced into the plasma PL while focusing onto the central axis X-X or the vicinity thereof of the plasma PL. This feature makes it possible to introduce the sample liquid Lf into the plasma PL without letting the plasma PL turn off.

The inner circumferential surface 122b of the gas supply tube 122 has a diameter that is constant in a range from the constriction portion 126 to the second outlet 122a. Such a configuration makes it possible to inhibit turbulence in the plasma gas Pf carrying the plasma ejected from the constriction portion 126, because no member blocks the flow of the plasma gas Pf. Note that in the shape of the gas supply tube 122, the diameter of the inner circumferential surface 122b may progressively increase from the constriction portion 126 toward the second outlet 122a.

In terms of ejecting droplets of the sample liquid Lf in a smaller lateral spreading range with respect to the ejection direction using the flow-focus effect of the flow of the plasma gas Pf, the opening diameter of the first outlet 21a of the liquid supply tube 21 is preferably smaller than the diameter of the outer circumferential surface 127c of the tip 127a of the protective tube 127 in the constriction portion 126.

Note that the nozzle 123 may have, instead of the constriction portion 126, the constriction portion 26 formed by the outer circumferential surface 21c of the liquid supply tube 21 and the inner circumferential surface 22b of the gas supply tube 22, which is illustrated in FIG. 1 described in association with the first embodiment. In this case, the constriction portion is formed by an outer circumferential surface 21c of the liquid supply tube 21 and the inner circumferential surface 122d of the gas supply tube 122 illustrated in FIG. 3.

### Third Embodiment

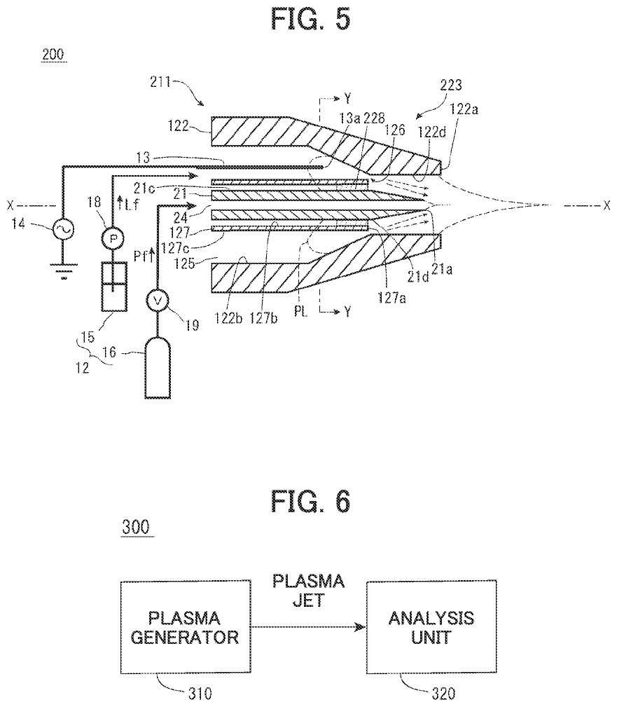

FIG. 5 is a diagram schematically illustrating a configuration of a plasma generator according to a third embodiment of the present invention. Referring to FIG. 5, a plasma generator 200 according to the third embodiment includes a plasma torch 211 that ejects a plasma jet, a supply unit 12 that supplies a sample liquid Lf and a plasma gas Pf to the plasma torch 211, and a high-frequency power source 14 that generates a high-frequency voltage and supplies the high-frequency voltage to an electrode 13 of the plasma torch 211. The plasma torch 211 is equivalent to the plasma torch 111 according to the second embodiment illustrated in FIGS. 3 and 4 in which the tip 127a of the protective tube 127 adjacent to the ejection end is blocked by a blocking member 228 filling a gap between the outer circumferential surface 21c of the liquid supply tube 21 and the inner circumferential surface 127b of the protective tube 127. The blocking member 228 is made from a dielectric material or an insulating material. The plasma torch 211 has the same configuration as the plasma torch 111 according to the second embodiment other than having the blocking member 228. According to this configuration, the blocking member 228 keeps the plasma gas Pf that has passed through the constriction portion 126 from entering the gap between the outer circumferential surface 21c of the liquid supply tube 21 and the inner circumferential surface 127b of the protective tube 127, inhibiting turbulence in the plasma gas Pf carrying the plasma PL.

Consequently, the atomization of the sample liquid Lf into fine droplets can be promoted, and the droplets of the sample liquid Lf can be introduced into the plasma PL while focusing onto the central axis X-X or the vicinity thereof of the plasma PL. This feature makes it possible to introduce the sample liquid Lf into the plasma PL without letting the plasma PL turn off. As a result, the plasma torch 211 can stably eject, in the form of a plasma jet, a component of the sample liquid that has reacted with the plasma.

### [Analysis Device]

FIG. 6 is a diagram schematically illustrating a configuration of an analysis device according to a fourth embodiment of the present invention. Referring to FIG. 6, an analysis device 300 includes a plasma generator 310 and an analysis unit 320 that performs an analysis using a plasma jet introduced from the plasma generator 310.

The plasma generator 310 is selected from among the plasma generators according to the first to third embodiments described above. The plasma generator 310 ejects droplets of the sample liquid Lf from the first outlet 21a of the liquid supply tube 21 into the flow of the plasma PL ejected. At the same time, the droplets of the sample liquid Lf are kept from dispersing to focus onto the central axis by the flow of the plasma PL and react with the plasma PL. Components of the droplets of the sample liquid are atomized or ionized by the plasma.

In a case where the analysis device 300 is a plasma mass spectrometry device, the analysis unit 320 has, for example, an ion lens, a quadrupole mass filter, and a detection unit (all not shown). The ion lens focuses ions of the components of the sample liquid that have been generated by the plasma generator 310. The quadrupole mass filter separates out specific ions based on a mass-to-charge ratio. The detection unit detects the specific ions for each mass number, and outputs corresponding signals. This analysis device 300 is capable of performing the same level of analysis as a conventional inductively coupled plasma mass spectrometry (ICP-MS) device.

In a case where the analysis device 300 is a plasma atomic emission spectrometry device, the analysis unit 320 has, for example, a spectroscope unit and a detection unit. When atoms resulting from the components of the sample liquid atomized and excited by the plasma generator 310 return to a low energy level, an emission spectral line is emitted. The spectroscope unit and the detection unit (both not shown) detect the emission spectral line, specify a component element from a wavelength of the emission line, and determine the component content from an intensity of the emission line. This analysis device 300 has a function of a conventional inductively coupled plasma atomic emission spectrometry (ICP-AES) device or a conventional microwave induced plasma atomic emission spectrometry device.

In the analysis device 300, the plasma generator 310 atomizes the sample liquid Lf being ejected from the first outlet 21a of the liquid supply tube 21 into fine droplets using the flow of the plasma gas Pf in which an atmospheric-pressure non-thermal equilibrium plasma (plasma PL) has been formed. The plasma generator 310 also keeps the droplets of the sample liquid Lf from dispersing using the flow of the plasma gas Pf, so that the droplets of the sample liquid Lf are introduced into the plasma PL while focusing onto the central axis or the vicinity thereof of the plasma PL. Thus, the sample liquid Lf can be directly introduced into the plasma PL. The analysis device 300 can therefore efficiently perform the analysis while reducing loss during the atomization of the sample liquid Lf into fine droplets.

The plasma generator 310 can be used as an ionization source capable of generating ions of components of a sample liquid. The analysis device 300 is a liquid chromatography mass spectrometry (LC/MS) device or a gas chromatography mass spectrometry (GC/MS) device including the plasma generator 310 as an ionization source.

### [Metal Particle Generator, Plasma Sterilizer, and Plasma Coater]

The plasma generators according to the first to third embodiments illustrated in FIGS. 1 to 5 can use, as the sample liquid Lf, an aqueous solution containing a precursor capable of forming particles using a plasma. Examples thereof include an aqueous metal compound solution containing an organic protectant. Examples of usable metal compounds include chloroauric acid, silver nitrate, and rhodium nitrate. The use of the plasma generators allows for formation of metal particles having a size of the order of nanometers.

The sample liquid Lf is water or a liquid containing an organic compound, an inorganic acid, or an inorganic alkali. Examples of liquids containing an organic compound, an inorganic acid, or an inorganic alkali include various aqueous solutions, organic solvents, ionic liquids, and oils such as edible oil and light mineral oil. The plasma generators can eject a plasma jet containing ozone or OH radicals by ejecting the sample liquid Lf into a plasma. The plasma generators can therefore perform modification, coating, sterilization, or the like of a surface of a target by spraying such a plasma jet onto the surface of the target.

### Example 1

In Example 1, the plasma generator according to the first embodiment illustrated in FIG. 1 was used to eject a plasma jet. Purified water (flow rate: 50 μL/min) was used as a sample liquid. Helium (He) (flow rate: 1.0 L/min) or argon (Ar) (flow rate: 0.8 L/min) was used as a plasma gas. The high-frequency voltage was set to a frequency of 50 Hz and a voltage of 4 kilovolts (kV).

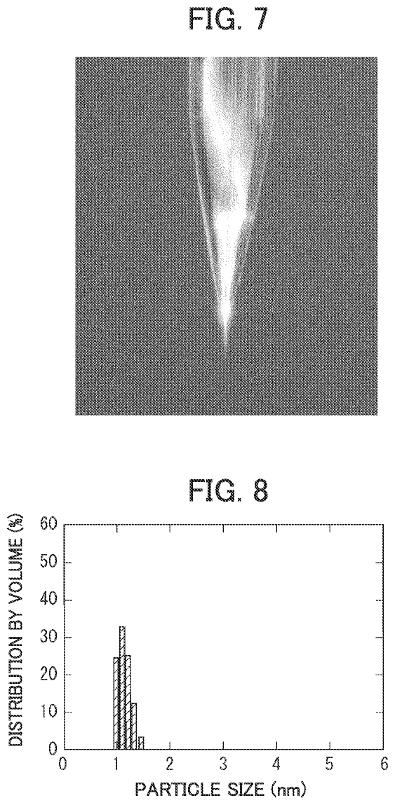

FIG. 7 is a diagram showing a plasma jet ejected by the plasma generator of Example 1. He gas was used for this plasma jet. FIG. 7 indicates that the plasma jet was formed and ejected from the plasma torch even though purified water had been directly supplied to the liquid supply tube. The use of Ar gas as the plasma gas also resulted in successful formation of a plasma jet.

### Example 2

In Example 2, the plasma generator according to the second embodiment illustrated in FIG. 3 was used to form gold nanoparticles. An aqueous chloroauric acid solution (concentration: 0.050 mol/L, flow rate: 50 μL/min) containing polyvinylpyrrolidone (PVP) as a protectant was used as a sample liquid. He gas (flow rate: 1.0 L/min) was used as a plasma gas. The high-frequency voltage was set to a frequency of 50 Hz and a voltage of 4 kilovolts (kV). The plasma generator was used to eject a plasma jet into a pan filled with water to generate gold nanoparticles. With respect to the water containing the gold nanoparticles, particle size distribution was measured by dynamic light scattering (model: Photal ELSZ-1000, manufactured by Otsuka Electronics Co., Ltd.).

FIG. 8 is a diagram showing the particle size distribution by volume of the gold nanoparticles generated using the plasma generator of Example 2. Referring to FIG. 8, measurements taken every 0.1 nm showed that gold nanoparticles with a particle size range of from 0.9 nm to 1.4 nm had been formed. This result indicates that the plasma generator of Example 2 is capable of forming fine gold nanoparticles with a narrow particle size range.

### Example 3

In Example 3, the analysis device according to the fourth embodiment of the present invention illustrated in FIG. 6 was used. The analysis device included, as a plasma generator, the plasma generator according to the second embodiment illustrated in FIG. 3 and, as an analysis unit, an inductively coupled plasma mass spectrometry (ICP-MS) device (model 7700x, manufactured by Agilent Technologies, Inc.) having an ion lens, a quadrupole mass filter, and a detection unit. As Comparative Example 1, an analysis device was used that included an inductively coupled plasma excitation source and a nebulizer in a normal configuration of model 7700x manufactured by Agilent Technologies, Inc. instead of the plasma generator used in Example 3.

Standard solutions (flow rate: 10 μL/min) of four arsenic compounds, arsenite (As(III)), arsenate (As(V)), methylarsinate (MA(V)), and dimethylarsenate (DMA(V)), were used as sample liquids. The standard arsenic compound solutions each contained 10 μg/kg of arsenic. Ar gas (flow rate: 0.8 L/min) was used as a plasma gas. In Example 3, the high-frequency voltage of the plasma generator according to the second embodiment was set to a frequency of 50 Hz and a voltage of 4 kilovolts (kV).

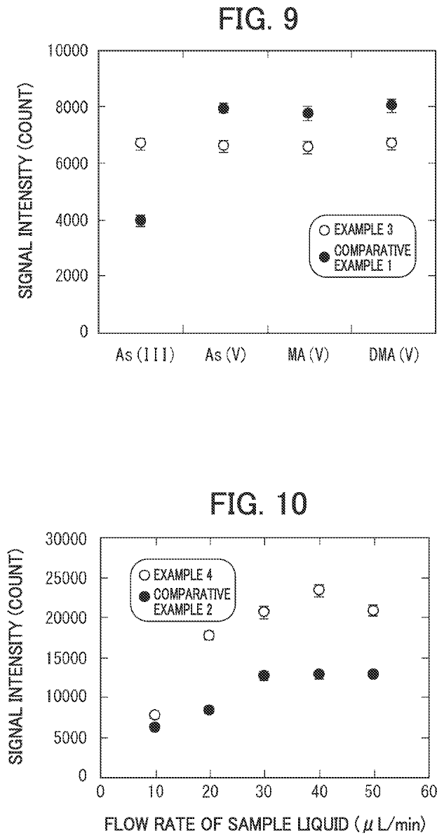

FIG. 9 is a diagram showing signal intensity of arsenic with respect to the four arsenic compounds measured using the analysis devices of Example 3 and Comparative Example 1. FIG. 9 indicates that the four arsenic compounds in Example 3 showed signal intensities that were equal or close to one another within a range of signal variation (1σ), whereas As(III) in Comparative Example 1 showed a sensitivity that went below the signal variation range and that was lower than those of the other arsenic compounds. It is known that in the case of a conventional ICP-MS device, the four arsenic compounds show large differences in sensitivity due to chemical interference in a plasma generated. By contrast, in the case of Example 3, the above results were achieved owing to the fact that all of the four arsenic compounds had been reduced to arsenite by a plasma jet ejected.

### Example 4

In Example 4, reduction and vaporization of mercury ions were measured. In Example 4, an analysis device having the same configuration as Example 3 was used. An analysis device having the same configuration as Comparative Example 1 was used as Comparative Example 2.

A standard mercury solution (concentration: 10 μg/kg, flow rate: 10 μL/min to 50 μL/min) was used as a sample liquid. Ar gas (flow rate: 0.8 L/min) was used as a plasma gas. The high-frequency voltage of the plasma generator was set to a frequency of 50 Hz and a voltage of 4 kilovolts (kV).

FIG. 10 is a diagram showing signal intensity of mercury in the reduction and vaporization of mercury ions measured using the analysis devices of Example 4 and Comparative Example 2. FIG. 10 indicates that in response to introduction of the standard mercury solution at a flow rate of 10 μL/min to 50 μL/min in Example 4, the signal intensity increased when the flow rate was 10 μL/min to 40 μL/min. In Comparative Example 2, the signal intensity increased when the flow rate was 10 μL/min to 30 μL/min, but the increase was smaller than that in Example 4. The signal intensity stayed unchanged when the flow rate was 40 μL/min to 50 μL/min. This is because in Comparative Example 2, there was a loss in adsorption of droplets ejected by the nebulizer in the spray chamber. By contrast, in Example 4, droplets of the standard mercury solution were ejected into the flow of the plasma PL ejected, and mercury ions were reduced and vaporized as Hg(0), reducing loss in adsorption of the droplets in the spray chamber and increasing the amount of mercury introduced into the analysis unit.

In the foregoing, the preferred embodiments of the present invention have been described in detail. However, the present invention is not limited to the specific embodiments, and various modifications and changes can be made within the scope of the present invention described in the claims. For example, the plasma torch according to the first embodiment may be combined with the plasma torch according to the second or third embodiment. For example, the plasma torch according to the first embodiment may have a configuration including the protective tube 127, and the protective tube 127 may have a configuration including the blocking member 228 at the tip 127a thereof adjacent to the ejection end.

For another example, the cross section of the liquid supply tube 21 and the first channel 24 therein are described as having a circular shape, but may alternatively have, for example, an oval shape, a triangular shape, a quadrilateral shape, a pentagonal shape, a hexagonal shape, or another polygonal shape. The shapes of the outer circumferential surface and the inner circumferential surface of the gas supply tubes 22 and 122 can be selected from among these shapes according to the shape of the liquid supply tube 21.

The plasma torch according to each of the embodiments of the present invention can be suitably applied to liquid sample introduction in analyzers, atomization sources or ionization sources of analyzers, nanoparticle production techniques, plasma jets for sterilization, and plasma jets for surface modification or coating as described above, but is not limited to these applications, whether described or not.

Regarding the above description, the following additional remarks disclose further embodiments. (Additional Remarks 1) A plasma torch capable of ejecting a plasma jet from one end thereof, the plasma torch including: a first tube having a first channel that allows a liquid to flow therethrough, the first tube having a first outlet from which the liquid is ejected toward the one end; a second tube surrounding the first tube with a gap therebetween and having a second channel that allows a gas to flow therethrough, the second tube having a second outlet from which the gas is ejected toward the one end, the second channel being defined by an outer circumferential surface of the first tube and an inner circumferential surface of the second tube; and an electrode extending in the second channel and having a tip located further toward an end opposite to the one end than the first outlet, the electrode being configured to receive a high-frequency voltage applied from the opposite end to form an atmospheric-pressure non-thermal equilibrium plasma in the gas, the second outlet being located further toward the one end than the first outlet, at least a portion of the inner circumferential surface of the second tube having a diameter that progressively decreases toward the second outlet, another portion of the inner circumferential surface of the second tube having a diameter that is equal to or greater than an opening diameter of the first outlet, the other portion of the inner circumferential surface of the second tube being located further toward the second outlet than the first outlet. (Additional Remarks 2) The plasma torch according to additional remarks 1, in which the second channel has a constriction portion located further toward the opposite end than the first outlet, and the second channel has a channel area that progressively decreases in a direction from the opposite end to the constriction portion.

(Additional Remarks 3) The plasma torch according to additional remarks 2, in which the inner circumferential surface of the second tube has a diameter that progressively increases from the constriction portion toward the second outlet. (Additional Remarks 4) The plasma torch according to additional remarks 2 or 3, in which the tip of the electrode is located further toward the opposite end than the constriction portion. (Additional Remarks 5) The plasma torch according to any one of additional remarks 2 to 4, in which the opening diameter of the first outlet of the first tube is smaller than a diameter of the outer circumferential surface of the first tube in the constriction portion. (Additional Remarks 6) The plasma torch according to any one of additional remarks 1 to 5 further including a third tube between the first tube and the second tube, the third tube surrounding the first tube, in which the second channel is defined by an outer circumferential surface of the third tube and the inner circumferential surface of the second tube, and the third tube has a tip adjacent to the one end, the tip of the third tube being located further toward the opposite end than the first outlet. (Additional Remarks 7) The plasma torch according to additional remarks 6, in which the tip of the third tube adjacent to the one end is blocked by a dielectric material or an insulating material disposed between an inner circumferential surface of the third tube and the outer circumferential surface of the first tube. (Additional Remarks 8) The plasma torch according to additional remarks 1 further including a third tube between the first tube and the second tube, the third tube surrounding the first tube, in which the second channel is defined by an outer circumferential surface of the third tube and the inner circumferential surface of the second tube, the third tube has a tip adjacent to the one end, the tip of the third tube being located further toward the opposite end than the first outlet, and the outer circumferential surface of the tip of the third tube adjacent to the one end and the inner circumferential surface of the second tube form a constriction portion. (Additional Remarks 9) The plasma torch according to additional remarks 8, in which the tip of the third tube adjacent to the one end is blocked by a dielectric material or an insulating material disposed between an inner circumferential surface of the third tube and the outer circumferential surface of the first tube. (Additional Remarks 10) The plasma torch according to additional remarks 8 or 9, in which the tip of the electrode is located further toward the opposite end than the constriction portion. (Additional Remarks 11) The plasma torch according to any one of additional remarks 8 to 10, in which the opening diameter of the first outlet of the first tube is smaller than a diameter of the outer circumferential surface of the third tube in the constriction portion. (Additional Remarks 12) The plasma torch according to any one of additional remarks 1 to 11, in which the electrode is wire-shaped or rod-shaped. (Additional Remarks 13) The plasma torch according to any one of additional remarks 1 to 12, in which the electrode does not have a counterpart electrode paired with the electrode. (Additional Remarks 14) The plasma torch according to any one of additional remarks 1 to 13, in which the first tube and the second tube are arranged such that a distance between the first outlet and the second outlet is 10 μm or more and 1000 μm or less. (Additional Remarks 15) The plasma torch according to any one of additional remarks 1 to 14, in which the second outlet of the second tube has an opening diameter of 100 μm or more and 500 μm or less. (Additional Remarks 16) The plasma torch according to any one of additional remarks 1 to 15, in which an inner circumferential surface of the first tube has a diameter that progressively decreases toward the first outlet. (Additional Remarks 17) The plasma torch according to any one of additional remarks 1 to 16, in which the outer circumferential surface of the first tube has a diameter that progressively decreases toward the first outlet. (Additional Remarks 18) The plasma torch according to any one of additional remarks 1 to 17, in which the first tube is pointed toward the first outlet in a cross-sectional shape thereof taken in a longitudinal direction of the plasma torch. (Additional Remarks 19) A plasma generator including: a liquid sample supply source configured to supply a liquid; a gas supply source configured to supply a gas; a high-frequency power source; and the plasma torch according to any one of additional remarks 1 to 18. (Additional Remarks 20) An analysis device including: the plasma generator according to additional remarks 19; and an analysis unit configured to analyze an atomized or ionized component of the liquid included in the plasma jet. (Additional Remarks 21) A metal particle generator including the plasma generator according to additional remarks 19, in which the liquid is an aqueous metal compound solution containing an organic protectant, and the metal particle generator forms metal particles through ejection of a plasma jet of the aqueous metal compound solution containing an organic protectant supplied to the first tube. (Additional Remarks 22) A plasma sterilizer including the plasma generator according to additional remarks 19, in which the liquid is water or a liquid containing an organic compound, an inorganic acid, or an inorganic alkali, and the plasma sterilizer ejects a plasma jet containing ozone or OH radicals from the liquid supplied to the first tube. (Additional Remarks 23) A plasma coater including the plasma generator according to additional remarks 19, in which the liquid is a liquid containing a coating material, and the plasma coater ejects a plasma jet containing the coating material from the liquid supplied to the first tube.

### EXPLANATION OF REFERENCE NUMERALS

10, 100, 200, 310: Plasma generator
11, 111, 211: Plasma torch
13: Electrode
14: High-frequency power source
21: Liquid supply tube
22, 122: Gas supply tube
23, 123, 223: Nozzle
24, 25, 125: Channel
26, 126: Constriction portion
127: Protective tube
300: Analysis device
320: Analysis unit
Lf: Sample liquid
Pf: Plasma gas
PL: Plasma

1. A plasma torch capable of ejecting a plasma jet from one end thereof, the plasma torch comprising:
a first tube having a first channel that allows a liquid to flow therethrough, the first tube having a first outlet from which the liquid is ejected toward the one end;
a second tube surrounding the first tube with a gap therebetween and having a second channel that allows a gas to flow therethrough, the second tube having a second outlet from which the gas is ejected toward the one end, the second channel being defined by an outer circumferential surface of the first tube and an inner circumferential surface of the second tube; and
an electrode extending in the second channel and having a tip located further toward an end opposite to the one end than the first outlet, the electrode being configured to receive a high-frequency voltage applied from the opposite end to form an atmospheric-pressure non-thermal equilibrium plasma in the gas,
the second outlet being located further toward the one end than the first outlet, at least a portion of the inner circumferential surface of the second tube having a diameter that progressively decreases toward the second outlet, another portion of the inner circumferential surface of the second tube having a diameter that is equal to or greater than an opening diameter of the first outlet, the other portion of the inner circumferential surface of the second tube being located further toward the second outlet than the first outlet.

2. The plasma torch according to claim 1, wherein the second channel has a constriction portion located further toward the opposite end than the first outlet, and
the second channel has a channel area that progressively decreases in a direction from the opposite end to the constriction portion.

3. The plasma torch according to claim 2, wherein the inner circumferential surface of the second tube has a diameter that progressively increases from the constriction portion toward the second outlet.

4. The plasma torch according to claim 2, wherein the tip of the electrode is located further toward the opposite end than the constriction portion.

5. The plasma torch according to claim 2, wherein the opening diameter of the first outlet of the first tube is smaller than a diameter of the outer circumferential surface of the first tube in the constriction portion.

6. The plasma torch according to claim 1, further comprising a third tube between the first tube and the second tube, the third tube surrounding the first tube, wherein
the second channel is defined by an outer circumferential surface of the third tube and the inner circumferential surface of the second tube, and
the third tube has a tip adjacent to the one end, the tip of the third tube being located further toward the opposite end than the first outlet.

7. The plasma torch according to claim 1, further comprising a third tube between the first tube and the second tube, the third tube surrounding the first tube, wherein
the second channel is defined by an outer circumferential surface of the third tube and the inner circumferential surface of the second tube,
the third tube has a tip adjacent to the one end, the tip of the third tube being located further toward the opposite end than the first outlet, and
the outer circumferential surface of the tip of the third tube adjacent to the one end and the inner circumferential surface of the second tube form a constriction portion.

8. The plasma torch according to claim 7, wherein the tip of the third tube adjacent to the one end is blocked by a dielectric material or an insulating material disposed between an inner circumferential surface of the third tube and the outer circumferential surface of the first tube.

9. The plasma torch according to claim 7, wherein the tip of the electrode is located further toward the opposite end than the constriction portion.

10. The plasma torch according to claim 7, wherein the opening diameter of the first outlet of the first tube is smaller than a diameter of the outer circumferential surface of the third tube in the constriction portion.

11. The plasma torch according to claim 1, wherein the electrode is wire-shaped or rod-shaped.

12. A plasma generator comprising:
a liquid supply source configured to supply a liquid;
a gas supply source configured to supply a gas;
a high-frequency power source; and
the plasma torch according to claim 1, wherein
the second tube is connected to the gas supply source, the first tube is connected to the liquid supply source, the electrode is connected to the high-frequency power source, and the plasma torch forms an atmospheric-pressure non-thermal equilibrium plasma in the gas using a high-frequency voltage applied from the high-frequency power source to the electrode and forms a plasma jet by ejecting a flow of the gas carrying the atmospheric-pressure non-thermal equilibrium plasma from the second channel and ejecting droplets of the liquid from the first outlet to the flow of the gas.

13. An analysis device comprising:
the plasma generator according to claim 12; and
an analysis unit configured to analyze an atomized or ionized component of the liquid included in the plasma jet.

14. The plasma torch according to claim 3, wherein the tip of the electrode is located further toward the opposite end than the constriction portion.

15. The plasma torch according to claim 3, wherein the opening diameter of the first outlet of the first tube is smaller than a diameter of the outer circumferential surface of the first tube in the constriction portion.

16. The plasma torch according to claim 4, wherein the opening diameter of the first outlet of the first tube is smaller than a diameter of the outer circumferential surface of the first tube in the constriction portion.

17. The plasma torch according to claim 8, wherein the tip of the electrode is located further toward the opposite end than the constriction portion.
